(19) United States
(12) Patent Application Publication
(10) Pub. No.: US 2006/0189714 A1
(43) Pub. Date: Aug. 24, 2006

(54) Water based ink set for ink-jet recording and inkjet recording method

(75) Inventors: Ryuji Kato, Aisai-shi (JP); Noriatsu Aoi, Ichinomiya-shi (JP); Narumi Kawai, Nagoya-shi (JP); Tomoyo Hamajima, Nagoya-shi (JP); Masaya Fujioka, Nagoya-shi (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: Brother Kogyo Kabushiki Kaisha

(21) Appl. No.: 11/356,925

(22) Filed: Feb. 16, 2006

(30) Foreign Application Priority Data
Feb. 23, 2005 (JP) 2005-047631

(51) Int. Cl. C03C 17/00

(52) U.S. Cl. 523/160

(57) ABSTRACT

A water based ink set for ink-jet recording, capable of reducing graininess, is composed of a combination of a diluting ink and one or more coloring inks. The diluting ink contains at least water and a water soluble organic agent and does not substantially contain a coloring agent, and the coloring ink contains at least a coloring agent, water and a water soluble organic solvent. In this ink set, the dynamic surface tension of the diluting ink is set to be higher than that of the coloring ink.

### BACKGROUND OF THE INVENTION

1. Field of the Invention

The present invention relates to a water based ink set for ink-jet recording and to an ink-jet recording method.

2. Description of the Related Art

In an ink-jet recording method, ink droplets are formed by means of an ink ejection method such as an electrostatic suction method, a method using a piezoelectric element to apply mechanical vibrations or displacement to ink, a method utilizing pressure generated when a gas bubble is generated by heating ink, or the like. Subsequently, all or part of the formed ink droplets are made to adhere to a recording material such as paper and the like to thereby perform recording.

When printing is performed with various gradations in an ink-jet printing apparatus which employs such an ink-jet recording method, a method is generally employed in which the density of the printing is determined by the density of ink dots formed on a recording material. However, in this method, the dot density decreases in low printing density areas, and thus, relative to this, the individual dots become easily discernable to the eye, thereby causing an image to be grainy in the low printing density areas. This is a known problem in the conventional technology.

In order to address the above problem, for example, an ink set has been known in which a plurality of inks having different dye concentrations are employed in combination for printing a series of similar colors. In this case, an ink having a lower dye concentration is employed for low printing density areas to attempt to reduce the graininess (Japanese Patent Application Laid-Open No. Hei 01-95093). Further, an ink set has been proposed which employs a low concentration ink and a high concentration ink each having the same color. In this case, the surface tension of the low concentration ink is set to be lower than that of the high concentration ink to improve the penetrability and the fixability of the inks (Japanese Patent Application Laid-Open No. 2001-179956). In addition, an ink set has been proposed which employs a colorless ink not containing a coloring agent and a coloring ink containing a coloring agent. In this case, the surface tension of the colorless ink is set to be lower than that of the coloring ink to improve the penetrability and the fixability of the inks (Japanese Patent Application Laid-Open Nos. Sho 63-315284 and 2002-121438). However, in such ink sets, the graininess of an image in low printing density areas is not satisfactorily improved. Further, in the above ink set of Japanese Patent Application Laid-Open No. 2001-179956, the number of the inks constituting the ink set increases since the low concentration ink and the high concentration ink are nozzle groups in an ink-jet head increases in an ink-jet printing apparatus, and thus a problem of an increase in cost arises.

### SUMMARY OF THE INVENTION

The present invention has been made to solve the above problems. Accordingly, it is an object of the present invention to provide a water based ink set for ink-jet recording capable of reducing the graininess of an image in low printing density areas and also to provide an ink-jet recording method for ink-jet recording capable of reducing the graininess of an image in low printing density areas.

The present inventors have found that, in a water based ink set for ink-jet recording comprising a diluting ink not substantially containing a coloring agent and a coloring ink containing a coloring agent, graininess can be reduced by adjusting the dynamic surface tension of the diluting and coloring inks. Therefore, an increase in the number of kinds of inks required in the ink set can be prevented, and thus a significant increase in the number of nozzle groups of an ink-jet head can be prevented. Thus, the present invention has been completed.

Accordingly, the present invention provides a water based ink set for ink-jet recording comprising a diluting ink and one or more coloring inks, the diluting ink containing at least water and a water soluble organic solvent and not substantially containing a coloring agent, the coloring inks containing at least a coloring agent, water and a water soluble organic solvent, wherein the dynamic surface tension of the diluting ink is higher than that of the coloring ink.

The present invention also provides an ink-jet recording method using the present water based ink set for ink-jet recording, wherein the diluting ink and the coloring ink are overprinted.

In the water based ink set for ink-jet recording and the ink-jet recording method of the present invention, the dynamic surface tension of the diluting ink is higher than that of the coloring ink. Thus, when the diluting ink and the coloring ink are overprinted, the coloring ink is diluted by mixing with the diluting ink on a recording material. Therefore, a low printing density image can be expressed without reducing the dot density of the inks. Further, the graininess of an image is reduced in low printing density areas, and thus excellent print quality can be obtained.

Also, in the present invention, when an image is formed by use of the diluting ink and the coloring inks, the diluting ink can be employed in combination with any of the coloring inks of various colors. Therefore, a low concentration coloring ink employed for expressing low printing density areas is not required to be provided for each of the colors of the coloring inks, and thus the number of nozzle groups of an ink-jet head is not required to significantly increase.

### DETAILED DESCRIPTION OF THE PREFERRED EMBODIMENTS

The present invention will be described below in detail.

The water based ink set for ink-jet recording of the present invention comprises a diluting ink and one or more coloring inks. The diluting ink contains at least water and a water soluble organic solvent and does not substantially contain a coloring agent, and the coloring inks contain at least a coloring agent, water and a water soluble organic solvent. The water based ink set is characterized in that the dynamic surface tension of the diluting ink is higher than that of the coloring ink. The dynamic surface tension is different from static surface tension and is a surface tension at a lifetime of the order of several tens to several thousands of ms. Thus, the dynamic surface tension has a considerable effect on the penetrability of an ink into a recording material when the ink is landed thereon. That is, if the dynamic surface tension of an ink is high, the ink penetrability into a recording material is low, and thus the drying characteristics of the ink are deteriorated. On the other hand, if the dynamic surface tension of an ink is low, the ink penetrability into a recording material is high, and thus the drying characteristics of the ink are improved. Therefore, in the present invention, the dynamic surface tension of the diluting ink is adjusted to be higher than that of the coloring inks. This may be achieved by properly adjusting the content of water, the kind of the water soluble organic solvent, the content of the water soluble organic solvent, the kind of surfactant, the content of the surfactant and the like. Hence, by overprinting the diluting ink and the coloring ink, the coloring ink is diluted by mixing with the diluting ink, and thus a low printing density image can be satisfactorily expressed.

The preferred value of the dynamic surface tension for the diluting ink at a lifetime of about 100 ms is about 50 mN/m or more and about 70 mN/m or less, as determined by a maximum bubble pressure method at about 25° C. The preferred value of the dynamic surface tension for the coloring ink at a lifetime of about 100 ms is about 35 mN/m or more and about 45 mN/m or less, as determined by a maximum bubble pressure method at about 25° C. By adjusting the dynamic surface tension of the diluting ink to about 50 mN/m or more, the penetrability of the diluting ink into a recording material is lowered. Thus, the dilution of the coloring ink by mixing with the diluting ink is facilitated on the recording material. On the other hand, if the dynamic surface tension of the diluting ink exceeds about 70 mN/m, difficulties arise in ejecting the diluting ink from an ink-jet head. Thus, the dynamic surface tension of the diluting ink is preferably about 70 mN/m or less.

Further, by adjusting the dynamic surface tension of the coloring ink to about 35 mN/m or more, feathering due to the excessive penetration of the coloring ink to a recording material can be prevented, where feathering means the irregular flow of the ink along the fibers of the recording material or the irregular penetration of the ink to the space among the fibers, and the deterioration of the ejection stability of the ink can also be prevented, which is caused by the excessive deterioration of water repellency on the nozzle surface of an ink-jet head. Further, by adjusting the dynamic surface tension of the coloring ink to about 45 mN/m or less, the coloring ink exhibits excellent drying characteristics on a recording material.

It has been known that the dynamic surface tension is generally determined by an oscillating jet method, a meniscus method, the maximum bubble pressure method, or other method. However, the preferred value of the abovementioned dynamic surface tension is a value determined by means of the maximum bubble pressure method under the abovementioned conditions.

In a general ink-jet recording method, the penetration phenomenon of ink to a recording material is completed in the order of several tens of ms after the ink is landed on the recording material. However, in the present invention, by taking into account errors in the measurement of dynamic surface tension or the like, the value of the dynamic surface tension at a lifetime of 100 ms is employed since the measurement accuracy is stable thereat.

In the measurement of the dynamic surface tension by mean of the maximum bubble pressure method, gas is supplied from a gas supplying source to a probe, and the probe is immersed in ink to generate a gas bubble from the end of the probe. In this case, the generation rate of the gas bubble is changed by changing the flow rate of the gas, and the change of the pressure on the gas bubble from the ink is measured to determine the dynamic surface tension by the following equation:
σ(dynamic surface tension)=(ΔP*r)/2.

In the equation, r is the radius of the end portion of the probe.

AP is the difference between the maximum value and the minimum value of the pressure on the gas bubble, and the pressure on the gas bubble reaches the maximum (the maximum bubble pressure) when the-radius of curvature of the gas bubble is equal to the radius of the end portion of the probe.

After the pressure reaches the maximum bubble pressure, the gas bubble moves away from the probe to form a new surface in the probe. The lifetime in the measurement of the dynamic surface tension is a period of time from when the new surface is formed to when the pressure again reaches the maximum bubble pressure.

The measurement of the dynamic surface tension by means of the maximum bubble pressure method can be performed by use of, for example, a dynamic surface tension meter (BP-D4, product of Kyowa Interface Science Co., LTD.).

In the present invention, the abovementioned relationship for the dynamic surface tension holds between the diluting ink and the coloring ink. In addition, these inks are prevented from reacting with each other. If the diluting ink and the coloring ink react with each other, the colorina aaent or other component aaareaates when these inks are overprinted, and thus the coloring ink is not satisfactorily diluted by mixing with the diluting ink on a recording material. Therefore, disadvantageously, the graininess reduction effect is not obtained.

Further, in the water based ink set for ink-jet recording of the present invention, the water employed in the diluting and coloring inks is not tap water containing ions and is preferably deionized water. The content of the water depends on the kind of the water soluble organic solvent, the composition of the ink and the desired characteristics of the ink, and is determined over a wide range. The content of the water with respect to the total amount of the ink is generally about 10 to about 95 wt. %, preferably about 10 to about 80 wt. % and more preferably about 20 to about 80 wt. %. The content less than about 10 wt. % is not preferable since the viscosity of the ink increases to cause difficulty in ejecting. Also, the content more than about 95 wt. % is not preferable since the coloring agent or an additive is precipitated or aggregated due to the evaporation of water to cause a nozzle of an ink-jet head to tend to be clogged.

The water soluble organic solvents employed in the diluting and coloring inks of the present invention are roughly categorized into a humectant and a penetrant. The water soluble orqanic solvent employed as the humectant is added to the ink for preventing clogging of nozzles of an ink-jet head. Specific examples of the humectant include water soluble glycols such as glycerin, ethylene glycol, diethylene glycol, triethylene glycol, polyethylene glycol, propylene glycol, dipropylene glycol, tripropylene glycol, polypropylene glycol, 1,5-pentanediol, 1,6-hexanediol and the like. The content of the water soluble organic solvent employed as the humectant is generally about 5 to about 50 wt. %, preferably about 10 to about 40 wt. % and more preferably about 15 to about 35 wt. %, with respect to the total amount of the corresponding ink. The content less than about 5 wt. % is not preferable since the clogging of nozzles of an ink-jet head is not satisfactorily prevented. Also, the content exceeding about 50 wt. % is not preferable since the viscosity of the ink increases to cause difficulty in ejecting.

The water soluble organic solvent employed as the penetrant is added to each of the inks for allowing the ink to penetrate into a recording material upon printing the ink and for adjusting the surface tension of the ink. Specific examples of the penetrant include glycol ethers typified by ethylene glycol-based alkyl ethers and propylene glycol-based alkyl ethers and the like. Specific examples of the ethylene glycol-based alkyl ether include ethvlene glycol methvl ether, ethylene glycol ethyl ether, ethylene glycol-n-propyl ether, ethylene glycol-n-butyl ether, ethylene glycol isobutyl ether, diethylene glycol methyl ether, diethylene glycol ethyl ether, diethylene glycol-n-propyl ether, diethylene glycol-n-butyl ether, diethylene glycol isobutyl ether, triethylene glycol methyl ether, triethylene glycol ethyl ether, triethylene glycol-n-propyl ether, triethylene glycol-n-butyl ether, triethylene glycol isobutyl ether and the like. Specific examples of the propylene glycol-based alkyl ether include propylene glycol methyl ether, propylene glycol ethyl ether, propylene glycol-n-propyl ether, propylene glycol-n-butyl ether, dipropylene glycol methyl ether, dipropylene glycol ethyl ether, dipropylene glycol-n-propyl ether, dipropylene glycol-n-butyl ether, tripropylene glycol methyl ether, tripropylene glycol ethyl ether, tripropylene glycol-n-propyl ether, tripropylene glycol-n-butyl ether and the like.

In the diluting ink, the content of the water soluble organic solvent employed as the penetrant is generally about 1 wt. % or less, and preferably about 0.5 wt. % or less, with respect to the amount of the diluting ink. The content exceeding about 1 wt. % is not preferable since the penetrability becomes excessively high to cause difficulties in diluting the coloring ink by mixing with the diluting ink on a recording material. Thus, the graininess of an image is not satisfactorily reduced in low printing density areas. In the coloring ink, the content of the water soluble organic solvent employed as the penetrant is generally about 1 to about 10 wt. % and preferably about 1 to about 7 wt. %, with respect to the amount of the coloring ink. The content less than about 1 wt. % is not practically preferable since the penetrability is not sufficient. Also, the content exceeding about 10 wt. % is not practically preferable since blurring such as feathering.tends to occur due to the excessively high penetrability.

In the present invention, the coloring ink may contain still other water soluble organic solvents in addition to the abovedescribed humectant and penetrant. These water soluble organic solvents are employed for preventing the ink from drying in the end portion of an ink-jet head, improving printing density, developing vivid color and achieving other purposes. Examples of such a water soluble organic solvent include: lower alcohols such as methyl alcohol, ethyl alcohol, n-propyl alcohol, isopropyl alcohol, n-butyl alcohol, sec-butyl alcohol, tert-butyl alcohol and the like; amides such as dimethylformamide, dimethylacetamide and the like; ketones and keto-alcohols such as acetone, diacetone alcohol and the like; ethers such as tetrahydrofuran, dioxane and the like; glycerin; pyrrolidones such as 2-pyrrolidone, N-methyl-2-pyrrolidone and the like; 1,3-dimethyl-2-imidazolidinone; and the like.

To the diluting ink and the coloring ink of the present invention, various surfactants may be added for adjusting the surface tension of each of the inks. Examples of the surfactant include: anionic surfactants such as higher alcohol sulfate ester salts, liquid fatty oil sulfate ester salts, alkyl allyl sulfonates and the like; non-ionic surfactants such as polyoxyethylene alkyl ether, polyoxyethylene alkyl ester sorbitan alkyl ester, polyoxyethylene sorbitan alkyl ester, and the like.

In the present invention, one or more inks selected from among, for example, a black ink, a yellow ink, a magenta ink and cyan ink may be employed as the coloring inks constituting the water based ink set for ink-jet recording. Each of the coloring inks contains a coloring agent. However, the diluting ink does not substantially contain a coloring agent. Herein, the diluting ink not substantially containing a coloring agent refers to that the diluting ink is colorless and transparent to the extent that, upon mixing the diluting ink with a coloring ink of arbitrary color, the color density of the coloring ink decreases but the color thereof does not change. In this case, for example, the diluting ink does not have a large absorption peak in the visible light range ranging in wavelength from about 300 to about 700 nm.

As the coloring agent, a water soluble dye and/or a pigment may be employed. As the water soluble dye, direct dyes, acid dyes, basic dyes, reactive dyes and the like can be used which satisfy the required vividness, water solubility, stability, light fastness and other properties, and are particularly suitable in an ink for an ink-jet recording method. Further, examples of the preferable water soluble dye include, if classified according to the structure thereof, azo dyes, metal complex dyes, naphthol dyes, anthraquinone dyes, indigo dyes, carbonium dyes, quinoneimine dyes, xanthene dyes, aniline dyes, quinoline dyes, nitro dyes, nitroso dyes, benzoquinone dyes, naphthoquinone dyes, phthalocyanine dyes, metal phthalocyanine dyes and the like.

Specific examples of the water soluble dye include: direct dyes such as C. I. Direct Blacks 17, 19, 32, 51, 71, 108, 146, 154 and 168, C. I. Direct Yellows 12,,24, 26, 27, 28, 33, 39, 5.8, 86, 98, 100, 132 and 142, C. I. Direct Reds 4, 17, 28, 37, 63, 75, 79, 80, 83, 99, 220, 224 and 227, C. I. Direct Violets 47, 48, 51, 90 and 94, C. I. Direct Blues 1, 6, 8, 15, 22, 25, 71, 76, 80, 86, 90, 106, 108, 123, 163, 165, 199 and 226, and the like; acid dyes such as C. I. Acid Blacks 2, 7, 24, 26, 31, 52, 63, 112 and 118, C. I. Acid Yellows 3, 11, 17, 19, 23, 25, 29, 38, 42, 49, 59, 61, 71 and 72, C. I. Acid Reds 1, 6, 8, 17, 18, 32, 35, 37, 42, 51, 52, 57, 80, 85, 87, 92, 94, 115, 119, 131, 133, 134, 154, 181, 186, 249, 254, 256, 289, 315, 317 and 407, C. I. Acid Violets 10, 34, 49 and 75, C. I. Acid Blues 9, 22, 29, 40, 59, 62, 93, 102, 104, 113, 117, 120, 167, 175, 183, 229 and 234, and the like; basic dyes such as C. I. Basic Black 2, C. I. Basic Yellow 40, C. I. Basic Reds 1, 2, 9, 12,.13, 14 and 37, C. I. Basic Violets 7, 14 and 27, C. I. Basic Blues 1, 3, 5, 7, 9, 24, 25, 26, 28 and 29, and the like; reactive dyes such as C. I. Reactive Yellows 2, 3, 13 and 15, C. I. Reactive Reds 4, 23, 24, 31, 56 and 180, C. I. Reactive Blues 7, 13 and 21, and the like.

The content of the water soluble dye in the coloring ink depends on the desired printing density and color. The content of the water soluble dye in the coloring ink is about 0.1 to about 10 wt. %, preferably about 0.3 to about 10 wt. % and more preferably about 0.5 to about 7 wt. %, with respect to the total amount of the coloring ink. The content less than about 0.1 wt. % is not preferable since the color is not satisfactorily developed on a recording material. Also, the content exceeding about 10 wt. % is not preferable since nozzles of an ink-jet head tend to be clogged.

As described above, a pigment may be employed in the coloring ink. Examples of the pigment of black color include carbon blacks such as MA8, MA100 (products of Mitsubishi Chemical Corporation), color black FW200 (product of Degussa) and the like. A self-dispersing pigment which can disperse or dissolve in water without using a dispersing agent may be employed as the carbon black. Such a self-dispersing pigment can be obtained by subjecting a pigment to a surface treatment such that at least one hydrophilic group such as a carbonyl group, a carboxyl group, a hydroxyl group,. a sulfone group or a salt of the hydrophilic group is bound to the surface of the pigment. Examples of the self-dispersing pigment include a pigment surface-treated by means of a method disclosed in Japanese Patent Application Laid-Open No. Hei 8-3498 (corresponding to U.S. Pat. No. 5,609,671) and a pigment surface-treated by means of a method disclosed in Published Japanese translation of PCT International Application No. 2000-513396 (corresponding to W097/48769) and the like. In addition, a commercial product such as CAB-O-JET (a registered trade mark) 200, 300 (products of Cabot Corporation), BONJET (a registered trade mark) CWl (product of Orient Chemical Industries, Ltd.) and the like may be employed as the self-dispersing pigment.

Examples of the pigment of yellow color include C. I. Pigment Yellows 3, 13, 74, 83, 154 and the like. Examples of the pigment of magenta color include C. I. Pigment Reds 5, 48, 112, 122, 177, 202, 207 and the like. Further, examples of the pigment of cyan color include C. I. Pigment Blues 15, 15:3, 15:4, 16, 60 and the like.

The content of the pigment contained in the coloring ink is generally about 1 to about 10 wt. % and preferably about 1 to about 7 wt. %, with respect to the amount of the coloring ink. The content less than about 1 wt. % is not preferable since the color is not satisfactorily developed on a recording material. Also, the content exceeding about 10 wt. % is not preferable since a nozzle of an ink-jet head tends to be clogged.

The basic composition of the diluting and coloring inks of the present invention is as described above. However, other conventionally known additives including surfactants; viscosity modifiers such as polyvinyl alcohol, cellulose and the like; mildewproofing agents; anticorrosive agents; and the like may be added in accordance with need.

The ink-jet recording method of the present invention employs the water based ink set for ink-jet recording having the abovementioned characteristics. When a low printing density image is formed, the diluting ink and the coloring ink are overprinted to thereby eliminate the graininess of the low printing density image.

When the diluting ink and the coloring ink are overprinted, these inks are ejected so as to be nearly simultaneously landed on a predetermined recording portion of a recording material. Herein, the nearly simultaneous landing of the diluting and coloring inks refers to that, after one of the inks is landed on a predetermined portion of a recording material, the other ink is landed within a certain period of time. This period of time is a short period of time to the extent that these inks can be mixed with each other before the first ink penetrates into the recording material and dries-thereon. In this case, normally, the landing time difference is one second or less.

Preferably, when the diluting ink and the coloring ink are overprinted, the diluting ink is first landed, and subsequently the coloring ink is landed. In this manner, the coloring ink is smoothly diluted by mixing with the diluting ink.

Preferably, when the diluting ink and the coloring ink are overprinted, the volume ratio of the ejection volume of the diluting ink to that of the coloring ink is about 50% to about 300%. In this case, the ejection volume of the diluting ink may be changed to provide gradation in accordance with need. In this manner, gradation can be expressed at color densities lighter than that of a conventional low concentration ink (a light ink)

In the ink-jet recording method of the present invention, no particular limitation is imposed on the ink ejection method. Examples of the ink ejection method which can be employed include an electrostatic suction method, a method using a piezoelectric element, a thermal method and the like.

### EXAMPLES

The present invention will next be specifically described by way of Examples and Comparative Examples.

(1) Preparation of Inks

Three types of the diluting inks and twenty types of the coloring inks (five types for each of the black, yellow, magenta and cyan color inks) each having the composition shown in Table 1 or 2 were prepared by means of the following methods.

(1-1) Preparation of the Diluting Inks

For each of the diluting inks, the ink components shown in Table 1 were mixed. Subsequently, the mixture was continued to stir for 30 minutes and filtrated with a membrane filter having a pore size of 1 μm to thereby prepare diluting inks 1 to 3.

(1-2) Preparation of the Coloring Inks

For each of the coloring inks, first, the ink components shown in Table 1 or 2 other than the coloring agent were mixed to prepare an ink solvent. Subsequently, the coloring agent component was added to the ink solvent under stirring. The mixture was continued to stir for 30 minutes and filtrated with a membrane filter having a pore size of 1 gm to thereby prepare black inks 1 to 5, yellow inks 1 to 5, magenta inks 1 to 5 and cyan inks 1 to 5. (1-3) Measurement of dynamic surface tension

Each of the inks prepared in (1-1) and (1-2) was subjected to dynamic surface tension measurement at a lifetime of 20 to 5,000 ms and 25° C. by use of a dynamic surface tension meter (BP-D4, product of Kyowa Interface Science Co., LTD.). Then, the value of the dynamic surface tension at a lifetime of 100 ms was read. The results are shown in Tables 1 and 2.

(2) Configuration of the Ink Sets

The inks prepared in (1) were combined as shown in Table 3 to form the ink sets of Examples 1 to 8 and Comparative Examples 1 and 2.

(3) Printing Test

(3-1) Preparation of Gradation Samples

The inks for each of the ink sets were filled in predetermined cartridges. Subsequently, the gradation samples on black, yellow, magenta and cyan colors were recorded for graininess evaluation on ordinary paper (DATA COPY paper, product of m-real) and on glossy paper (KASSAI (a registered trade mark) photo finishing, product of FUJI Photo Film Co., Ltd.). In this case, a digital multifunction device equipped with an ink-jet printer (MFC-5200J, product of brother industries, Ltd.) was employed. For the ink sets containing the diluting ink, the diluting ink was first ejected to a portion to be recorded by the coloring ink including the black, yellow, magenta or cyan ink. Subsequently, the coloring ink of the same amount as the diluting ink was overprinted thereon. Further, the gradation samples were formed by changing the density of the overprinted dots.

(3-2) Preparation of Text Printing

Text printing samples for each of the inks were prepared for evaluating feathering and paper drying characteristics. In this case, the multifunction device same as that employed in (3-1) was employed, and the samples were recorded on ordinary paper without using the diluting ink.

(4) Evaluation

(4-1) Evaluation of Graininess

Low printing density areas in each of the color gradation samples prepared in (3-1) were visually observed, and the graininess was evaluated by the following criteria. The results are shown in Table 3.

A: Graininess is not found.

B: Graininess is almost unnoticeable.

C: Graininess is noticeable.

D: Graininess is highly noticeable. Practically unsuitable.

(4-2) Evaluation of Feathering

Each of the color text printing samples prepared in

(3-2) was visually observed, and the effects of feathering on the image were evaluated by the following criteria. The results are shown in Table 3.

A: Feathering is not found.

B: Feathering is almost unnoticeable.

C: Feathering is noticeable.

D: Feathering is highly noticeable. Practically unsuitable.

(4-3) Evaluation of drying characteristics on paper

Each of the color text printing samples prepared in

(3-2) was rubbed with a finger at 15 seconds after the printing. Subsequently, blurring of the ink was visually observed and was evaluated by the following criteria. The results are shown in Table 3.

A: Ink blurring is not found.

B: Ink blurring is almost unnoticeable.

C: Ink blurring is noticeable.

D: Ink blurring is highly noticeable. Practically unsuitable.

TABLE 1

| | | Diluting ink | | | Black ink | | | | | Yellow ink | | | | |
|---|---|---|---|---|---|---|---|---|---|---|---|---|---|---|
| | | 1 | 2 | 3 | 1 | 2 | 3 | 4 | 5 | 1 | 2 | 3 | 4 | 5 |
| Ink | Water (ion-exchanged water) | 73.9 | 73.9 | 73.7 | 68.0 | 68.0 | 68.0 | 68.0 | 67.7 | 68.0 | 68.0 | 68.0 | 68.0 | 67.7 |
| composition | Glycerin | 26.0 | 25.5 | 21.0 | 26.0 | 27.0 | 24.0 | 28.0 | 24.0 | 27.0 | 28.0 | 25.0 | 29.0 | 25.0 |
| (wt. %) | Dipropylene glycol-n-propyl ether | — | 0.5 | — | 3.0 | 2.0 | 5.0 | 1.0 | — | 3.0 | 2.0 | 5.0 | 1.0 | — |
| | Triethylene glycol-n-butyl ether | — | — | 5.0 | — | — | — | — | 5.0 | — | — | — | — | 5.0 |
| | Polyoxyethylene lauryl ether | 0.1 | 0.1 | — | — | — | — | — | — | — | — | — | — | — |
| | sodium sulfate (*1) | | | | | | | | | | | | | |
| | Olfin E1010 (*2) | — | — | 0.3 | — | — | — | — | 0.3 | — | — | — | — | 0.3 |
| | C.I. Direct Black 154 | — | — | — | 3.0 | 3.0 | 3.0 | 3.0 | 3.0 | — | — | — | — | — |
| | C.I. Direct Yellow 86 | — | — | — | — | — | — | — | — | 0.4 | 0.4 | 0.4 | 0.4 | 0.4 |
| | C.I. Direct Yellow 132 | — | — | — | — | — | — | — | — | 1.6 | 1.6 | 1.6 | 1.6 | 1.6 |
| | C.I. Reactive Red 180 | — | — | — | — | — | — | — | — | — | — | — | — | — |
| | C.I. Direct Blue 199 | — | — | — | — | — | — | — | — | — | — | — | — | — |
| Evaluation | Dynamic surface | 65.3 | 51.8 | 31.6 | 40.7 | 44.0 | 36.4 | 49.8 | 32.1 | 40.3 | 44.2 | 36.6 | 49.5 | 31.9 |
| | tension (mN/m) | | | | | | | | | | | | | |

(*1) Average polymerization degree of oxyethylene = 3
(*2) An adduct of acetylene glycol with ethylene oxide, product of Nissin Chemical Industry Co., Ltd.

TABLE 2

| | | Magenta ink | | | | | Cyan ink | | | | |
|---|---|---|---|---|---|---|---|---|---|---|---|
| | | 1 | 2 | 3 | 4 | 5 | 1 | 2 | 3 | 4 | 5 |
| Ink | Water (ion-exchanged water) | 68.0 | 68.0 | 68.0 | 68.0 | 67.7 | 68.0 | 68.0 | 68.0 | 68.0 | 67.7 |
| composition | Glycerin | 26.5 | 27.5 | 24.5 | 28.5 | 24.5 | 26.1 | 27.1 | 24.1 | 28.1 | 24.1 |
| (wt. %) | Dipropylene glycol-n-propyl ether | 3.0 | 2.0 | 5.0 | 1.0 | — | 3.0 | 2.0 | 5.0 | 1.0 | — |
| | Triethylene glycol-n-butyl ether | — | — | — | — | 5.0 | — | — | — | — | 5.0 |
| | Polyoxyethylene lauryl ether sodium | — | — | — | — | — | — | — | — | — | — |
| | sulfate (*1) | | | | | | | | | | |
| | Olfine E1010 (*2) | — | — | — | — | 0.3 | — | — | — | — | 0.3 |
| | C.I. Direct Black 154 | — | — | — | — | — | — | — | — | — | — |
| | C.I. Direct Yellow 86 | — | — | — | — | — | — | — | — | — | — |
| | C.I. Direct Yellow 132 | — | — | — | — | — | — | — | — | — | — |
| | C.I. Reactive Red 180 | 2.5 | 2.5 | 2.5 | 2.5 | 2.5 | — | — | — | — | — |
| | C.I. Direct Blue 199 | — | — | — | — | — | 2.9 | 2.9 | 2.9 | 2.9 | 2.9 |
| Evaluation | Dynamic surface tension (mN/m) | 40.6 | 43.9 | 36.5 | 49.7 | 32.0 | 40.5 | 44.1 | 36.6 | 49.2 | 32.3 |

(*1) Average polymerization degree of oxyethylene = 3
(*2) An adduct of acetylene glycol with ethylene oxide, product of Nissin Chemical Industry Co., Ltd.

TABLE 3

| | | | | Ex. | Ex. | Ex. | Ex. | Ex. | Ex. | Ex. | Ex. | Comp. | Comp. |
|---|---|---|---|---|---|---|---|---|---|---|---|---|---|
| | | | | 1 | 2 | 3 | 4 | 5 | 6 | 7 | 8 | Ex. 1 | Ex. 2 |
| Ink | Diluting ink | | | 1 | 2 | 1 | 2 | 2 | 2 | 1 | 1 | — | 3 |
| set | Black ink | | | 1 | 1 | 2 | 2 | 3 | 4 | 4 | 5 | 1 | 1 |
| | Yellow ink | | | 1 | 1 | 2 | 2 | 3 | 4 | 4 | 5 | 1 | 1 |
| | Magenta ink | | | 1 | 1 | 2 | 2 | 3 | 4 | 4 | 5 | 1 | 1 |
| | Cyan ink | | | 1 | 1 | 2 | 2 | 3 | 4 | 4 | 5 | 1 | 1 |
| Printing | Graininess | Black | Ordinary paper | A | A | A | A | A | A | A | B | D | D |
| test/ | | | Glossy paper | A | B | A | B | B | B | A | B | D | D |
| evaluation | | Yellow | Ordinary paper | A | A | A | A | A | A | A | B | D | D |
| | | | Glossy paper | A | B | A | B | B | B | A | B | D | D |
| | | Magenta | Ordinary paper | A | A | A | A | A | A | A | B | D | D |
| | | | Glossy paper | A | B | A | B | B | B | A | B | D | D |
| | | Cyan | Ordinary paper | A | A | A | A | A | A | A | B | D | D |
| | | | Glossy paper | A | B | A | B | B | B | A | B | D | D |
| | Feathering | Black | Ordinary paper | A | A | A | A | B | A | A | C | A | A |
| | | Yellow | | A | A | A | A | B | A | A | C | A | A |
| | | Magenta | | A | A | A | A | B | A | A | C | A | A |
| | | Cyan | | A | A | A | A | B | A | A | C | A | A |
| | Drying | Black | Ordinary paper | A | A | B | B | A | C | C | A | A | A |
| | characteristics | Yellow | | A | A | B | B | A | C | C | A | A | A |
| | on paper | Magenta | | A | A | B | B | A | C | C | A | A | A |
| | | Cyan | | A | A | B | B | A | C | C | A | A | A |

In the ink sets of Examples 1 to 8, the dynamic surface tension of the diluting ink is higher than that of the coloring inks. Therefore, the graininess in the samples of each of the ink sets was a practically usable level.

Further, upon overprinting the diluting ink on the less graininess could be obtained by changing the ratio of the ejection volume of the overprinting diluting ink to that of the coloring ink.

Particularly, in the ink sets of Examples 1 to 5, the dynamic surface tension of the diluting ink at a lifetime of 100 ms was 50 mN/m or more and 70 mN/m or less, as determined by the maximum bubble pressure method at 25° C. In addition, the dynamic surface tension of the coloring inks at a lifetime of lOOms was 35 mN/m or more and 45 mN/m or less, as determined by the maximum bubble pressure method at 25° C. Therefore, the graininess and the feathering were unnoticeable, and the drying characteristics on paper were excellent.

In contrast to the ink sets of Examples 1 to 8, in the ink sets of Comparative Examples 1 and 2, the diluting ink is not included (Comparative Example 1), or the dynamic surface tension of the diluting ink is lower than that of the coloring inks (Comparative Example 2). Therefore, the graininess was highly noticeable, and the ink sets were practically unsuitable.

The entire disclosure of the specification, claims and summary of Japanese Patent Application No. 2005-047,631 filed on Feb. 23, 2005 is hereby incorporated by reference.

What is claimed is:

1. A water based ink set for ink-jet recording comprising:
a diluting ink containing at least water and a water soluble organic solvent and not substantially containing a coloring agent; and
one or more coloring inks containing at least a coloring agent, water and a water soluble organic solvent, wherein
a dynamic surface tension of the diluting ink is higher than that of the coloring ink.

2. The water based ink set for ink-jet recording according to claim 1, wherein a dynamic surface tension for the diluting ink at a lifetime of about 100 ms is about 50 mN/m or more and about 70 mN/m or less, and a dynamic surface tension for the coloring ink at a lifetime of about 100 ms is about 35 mN/m or more and about 45 mN/m or less, as determined by a maximum bubble pressure method at about 25° C.

3. The water based ink set for ink-jet recording according to claim 1, wherein the diluting ink and the coloring ink do not react with each other.

4. The water based ink set for ink-jet recording according to claim 1, wherein the coloring ink is one selected from the group consisting of a black ink, a yellow ink, a magenta ink and a cyan ink.

5. An ink-jet recording method using the water based ink set for ink-jet recording according to any one of claim 1, wherein the diluting ink and the coloring ink are overprinted.

6. The ink-jet recording method according to claim 5, wherein the coloring ink is landed on a portion where the diluting ink has been landed.

7. The ink-jet recording method according to claim 5, wherein when the diluting ink and the coloring ink are overprinted, a ratio of an ejection volume of the diluting ink to an ejection volume of the coloring ink is changed to provide gradation.
